(19) United States
(12) Patent Application Publication
(10) Pub. No.: US 2018/0245233 A1
(43) Pub. Date: Aug. 30, 2018

(54) INTELLIGENT WATER CONTROL EQUIPMENT FOR INTERMITTENTLY COUNTERCURRENT RINSING PLATING ARTICLES AND AUTOMATIC WATER CONTROL METHOD THEREOF

(71) Applicants: South China Institute of Environmental Sciences. MEP, GUANGZHOU (CN); Nanjing University, NANJING (CN)

(72) Inventors: JIANWEI DU, GUANGZHOU (CN); YONG WEN, GAUNGZHOU (CN); FUQIANG LIU, NANJING (CN); KUANG HE, GUANGZHOU (CN); WEI ZHAO, NANJING (CN); MINGYANG ZHANG, GUANGZHOU (CN); AIMIN LI, NANJING (CN); YING MA, GUANGZHOU (CN)

(73) Assignees: South China Institute of Environmental Sciences. MEP; NANJING UNIVERSITY

(21) Appl. No.: 15/693,826

(22) Filed: Sep. 1, 2017

(30) Foreign Application Priority Data
Feb. 27, 2017 (CN) 201710109161.8

(51) Int. Cl. C25D 21/08; B08B 3/08; B08B 3/10; C11D 7/26; C11D 7/36; C11D 11/00

(52) U.S. Cl. CPC C25D 21/08; B08B 3/08; B08B 3/102; C11D 11/0047; C11D 7/265; C11D 7/36; C11D 7/261

(57) ABSTRACT

The disclosure provides an intelligent water control equipment for intermittently countercurrent rinsing plating articles, comprising: a multi-stage countercurrent rinse tank, a PLC automatic control system, a liquid level sensor, a water supply pump, a water discharge pump, a water inlet pipe and a water output pipe; the multi-stage countercurrent rinse tank is composed of n rinse tanks connected in series, the water inlet pipe of a preceding-stage rinse tank is connected with the water outlet pipe of a next-stage rinse tank, rinse water is conveyed to the final-stage rinse tank through the water supply pump, the water flow direction is opposite to the movement direction of plating articles; signals of the liquid level sensor and a conductivity electrode are input to the PLC automatic control system.

### CROSS-REFERENCE TO RELATED APPLICATIONS

This application claims priority to Chinese Patent Application No. 201710109181.8 with a filing date of Feb. 27, 2017. The content of the aforementioned applications, including any intervening amendments thereto, are incorporated herein by reference.

### TECHNICAL FIELD

The disclosure relates to the technology of automatic control of electroplating rinse water supply and discharge, and in particular to an intelligent water control equipment for intermittently countercurrent rinsing plating articles and a use method thereof.

### BACKGROUND OF THE PRESENT INVENTION

Plating article rinsing is an important part of electroplating production, poor rinsing effect not only impacts electroplating quality but also makes a next procedure of plating solution polluted. Many electroplating factories frequently use excessive amounts of rinse water so as to guarantee the rinsing quality of plating articles, thus causing serious water resource waste; in China, electroplating industries discharge up to 4 billion tons of waste water containing heavy metals every year. The fundamental reason that electroplating rinsing consumes excessive water is that there lacks effective automatic water control means at present and the usage amount of rinse water is determined by operators according to experiences.

Conductivity water control technology is a method for realizing automatic control of rinse water supply and discharge by adjusting the conductivity of the rinse water. The working principle is to monitor the concentration of the plating solution in the rinse water through a conductivity sensor according to the positive correlation between the concentration and the conductivity of the electroplating solution in the rinse water. When the conductivity in the rinse water exceeds a maximum allowed value, a water supply valve is opened to supply clean water; when the conductivity in the rinse water is less than a preset value, a solenoid valve is closed to stop supplying water. This method may improve the randomness of opening and closing the water supply valve and prevent the phenomenon of water keeping running. At present, automatic conductivity water control technologies mostly are applied to continuous countercurrent rinsing processes. Among the many rinsing ways, intermittent countercurrent rinsing is the most basic water conservation rinsing method; meanwhile, as the increase of the stages of rinse tanks, the usage amount of rinse water is reduced.

### SUMMARY OF PRESENT INVENTION

The technical problem to be solved by the disclosure is to provide an intermittent countercurrent rinsing intelligent water control equipment in view of the current situation that current electroplating rinse technologies have high water consumption and lack automatic control means, so as to realize automatic control of electroplating rinse water supply and discharge and save the usage amount of rinse water to the maximum extent.

The technical scheme of the disclosure is as follows.

An intelligent water control equipment for intermittently countercurrent rinsing plating articles includes a multi-stage countercurrent rinse tank, a PLC automatic control system, a liquid level sensor, a water supply pump a water discharge pump, a water inlet pipe and a water output pipe; the multi-stage countercurrent rinse tank is composed of n rinse tanks connected in series, n being a natural number greater than 2 but less than 10, representing a first-stage rinse tank, a second-stage rinse tank . . . a final-stage rinse tank in turn, the water inlet pipe is arranged on the top part of each stage of rinse tank, the water outlet pipe is arranged on the bottom part of each stage of rinse tank, the water inlet pipe of a preceding-stage rinse tank is connected with, the water outlet pipe of a next-stage rinse tank, rinse water is conveyed to the final-stage rinse tank through the water supply pump, the water flow direction is opposite to the movement direction of plating articles; an emptying valve is arranged on the bottom part of each stage of rinse tank and is connected to an emptying pipe, through which the rinse water in the rinse tank is emptied; electromagnetic valves are arranged on both the water inlet pipe and the water outlet pipe, the liquid level, sensor is arranged on the bottom part of each rinse tank, the top part of the final-stage rinse tank is also provided with a liquid level sensor, a conductivity electrode is arranged in the second last stage of rinse tank, signals of the liquid level sensor and the conductivity electrode are input to the PLC automatic control system, and a signal output end of the PLC automatic control system is electrically connected with a control circuit of the water supply pump and the water discharge pump.

Further, in the above scheme, a flow meter is equipped between two adjacent stages of rinse tanks or a delivery pump adopts a flow pump.

Further, in the above scheme, the rinse tank is of anticorrosion steel structure, which is durable.

Further, in the above scheme, the first-stage rinse tank is further provided with a detergent feeding device, for the convenience of detergent feeding.

Further, in the above scheme, the PLC automatic control system includes a control module, a display screen, a power module and a monitoring module; the control module and the monitoring module are electrically connected with each other, signals of the liquid level sensor and the conductivity electrode are input to the monitoring module of the PLC automatic control system, so that the PLC automatic control system collects the information sensed by the conductivity electrode and the liquid level sensor in time and then transmits the signal to the control module of the PLC automatic control system, a signal output end of the control module is electrically connected with the control circuit of the water supply pump and the water discharge pump to control the switch of each water supply pump so as to realize automatic control of water supply and discharge; meanwhile, the control module also controls the automatic operation of the system; the control module, the display screen and the monitoring module all are powered by the power module, and the signal received by the control module is synchronously displayed through the display screen.

A use method of the intelligent water control equipment for intermittently countercurrent rinsing plating articles includes the following steps:

1) at the initial stage of rinsing, what in each stage of rinse tank being rinse water, feeding detergent to the first-stage rinse tank, the detergent being a mixed liquor composed of absolute ethyl alcohol, isopropyl alcohol, dimer fatty acid and amine phosphate, with a mass ratio of 7:2:1:1, the dosage of the detergent being 0.1-1.2 g/L, wherein, as rinsing time increases, the concentration of each stage of rinse tank increases gradually;

2) when the conductivity of the second last stage of rinse tank reaches a preset upper limit, the conductivity electrode transmitting a signal to the PLC automatic control system, the PLC automatic control system triggering the program of automatic water change to start changing water, and, feeding one time detergent to the first-stage rinse tank each time water is changed; the system first automatically opening the water discharge pump of the first-stage rinse tank to discharge the rinse water in the first-stage rinse tank; after the first-stage rinse tank is emptied, totally inputting the second-stage rinse water to the first-stage rinse tank through the PLC automatic control system, latter stages of rinse tanks changing water in turn, and, when the final-stage rinse tank is emptied, triggering the water supply pump to infuse clean rinse water to the final-stage rinse tank, the water supply pump being connected with a normal-temperature water tank and a hot water tank respectively for alternately supplying normal-temperature water and hot water, the temperature of the normal-temperature water being 20±5° C. and the temperature of the hot water being about 80±10° C.

3) when the final-stage rinse tank is full of rinse water, triggering the liquid level sensor arranged on the top part, the liquid level sensor transmitting a signal to the PLC automatic control system, and the PLC automatic control system triggering the water supply pump to stop supplying water, the system being capable of monitoring the water flow of water change of each stage of rinse tank and finding the leakage and venting condition of rinse water in times,

4) when inspecting and debugging the device, changing the PLC automatic control system to manual control, so that the rinse water may be emptied manually through the emptying valve to facilitate equipment repair.

Further, the amine phosphate is acidic amine phosphate.

Further, the preparation method of the detergent is: taking absolute ethyl alcohol, isopropyl alcohol, dimer fatty acid and acidic amine phosphate according to the mass ratio; pumping the dimer fatty acid into a blending kettle to heat to 35 to 4° C., then adding the acidic amine phosphate to stir for 1 to 5 min, next adding the absolute ethyl alcohol and the isopropyl alcohol, mixing thoroughly, ready to use.

The disclosure has benefits as follows: the intelligent water control equipment for intermittently countercurrent rinsing plating articles of the disclosure controls the multi-stage countercurrent rinse tank through the PLC automatic control system, the PLC automatic control system may realize automatic operation, liquid level control and conductivity control, and each device may be started in turn according to a preset program when the rinsing equipment needs to change water; through the liquid level control, it is guaranteed that the final-stage rinse tank does not overflow and that no residual rinse water is left in each stage of rinse tank when each stage of rinse tank changes water; through the conductivity control, when the conductivity of the rinse water exceeds a preset value, a program is started to change the rinse water in each stage of rinse tank in turn. Therefore, the disclosure realizes automatic control of electroplating rinse water supply and discharge and saves the usage amount of rinse water to the maximum extent.

### DESCRIPTION OF THE DRAWINGS

FIG. 1 is a structure diagram of an Embodiment 1 of the disclosure.

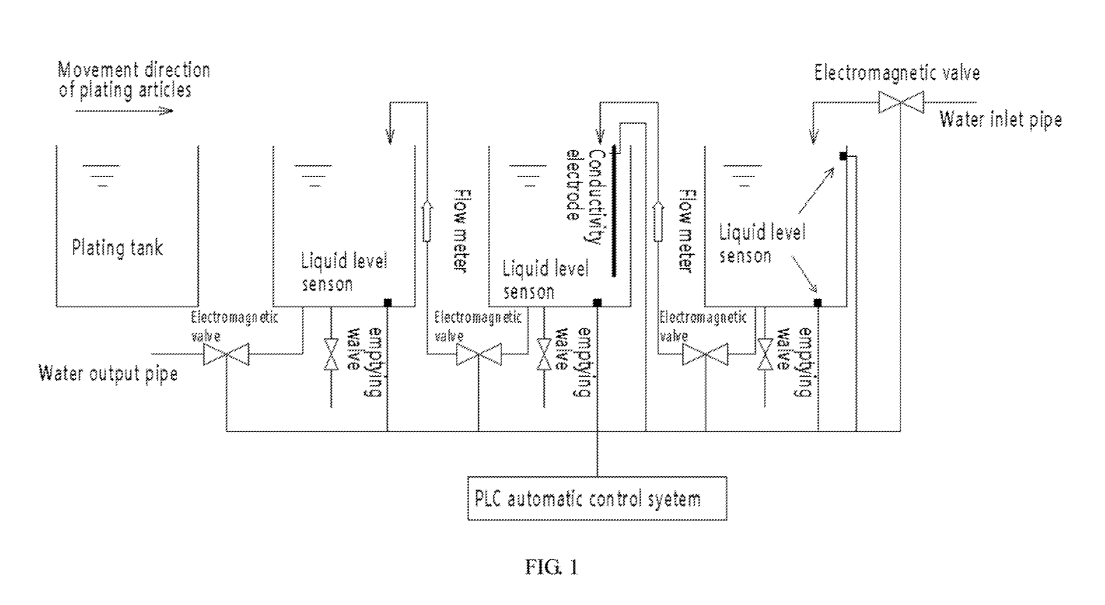

FIG. 2 is a structure diagram of an Embodiment 2 of the disclosure.

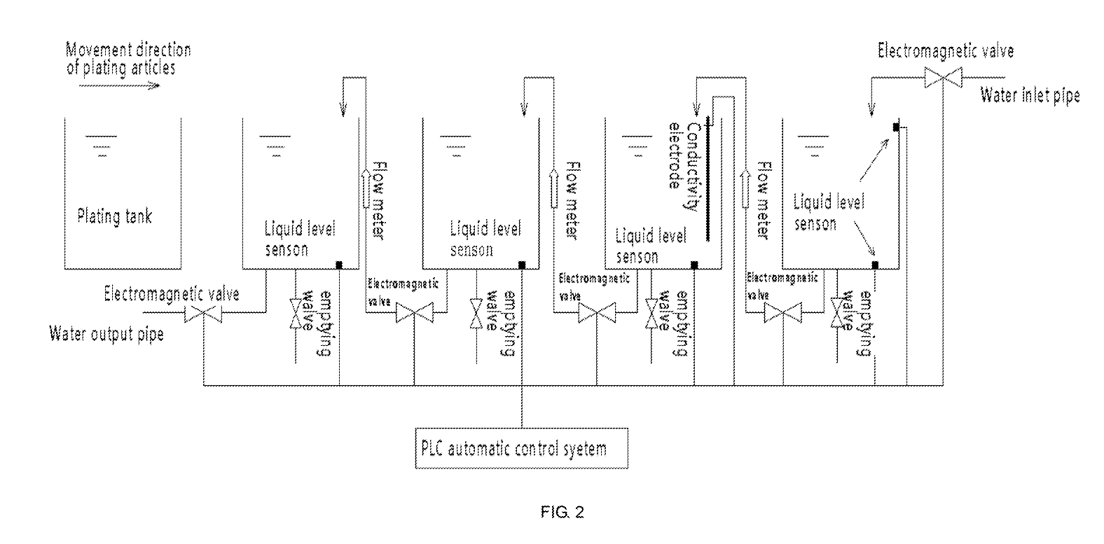

FIG. 3 is a structure diagram of an Embodiment 3 of the disclosure.

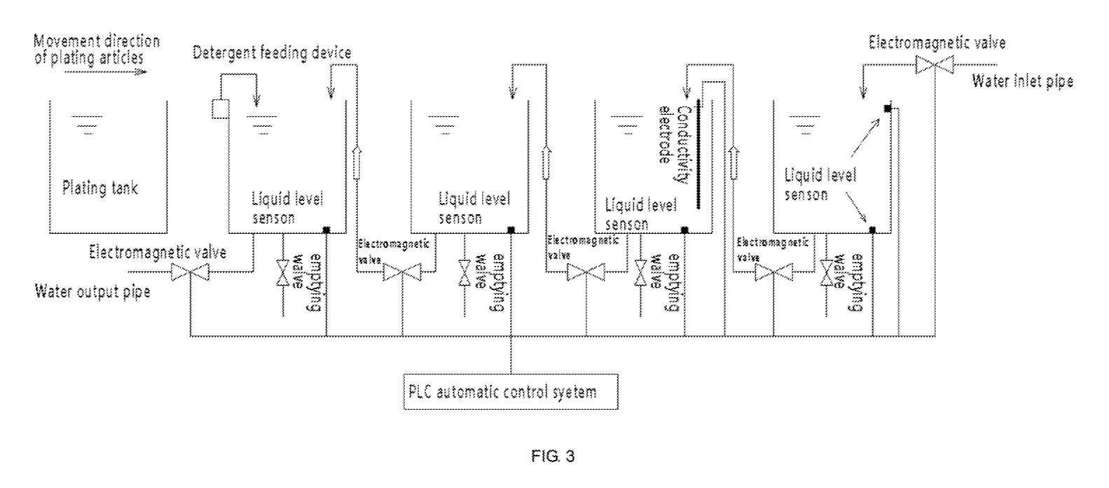

FIG. 4 is a structure diagram of an Embodiment 4 of the disclosure.

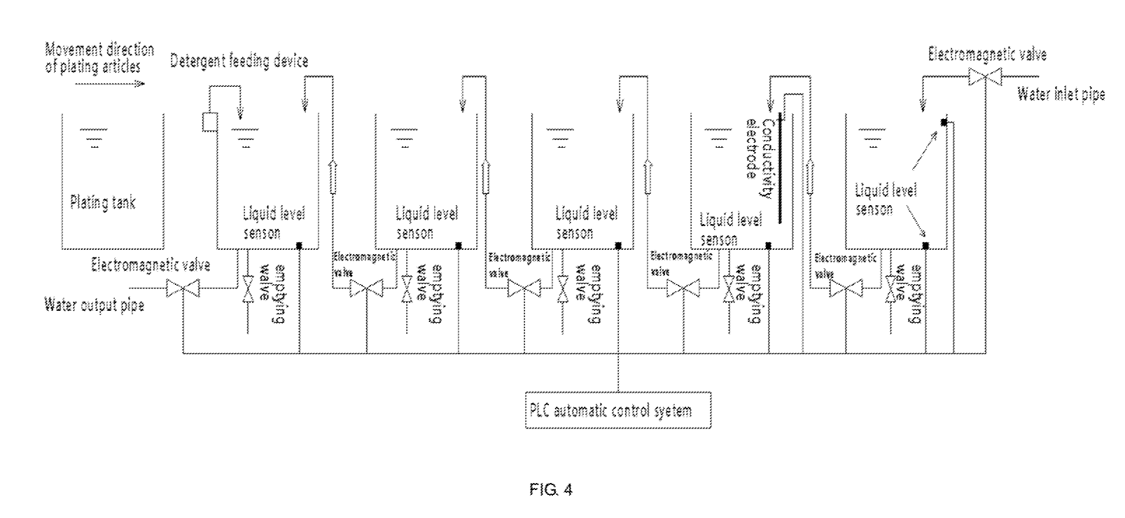

### DETAILED DESCRIPTION OF PREFERRED EMBODIMENTS

### Embodiment 1

An intelligent water control equipment for intermittently countercurrent rinsing plating articles includes a three-stage countercurrent rinse tank, a PLC automatic control system, a liquid level sensor, a water supply pump, a water discharge pump, a water inlet pipe and a water output pipe; the multi-stage countercurrent rinse tank is composed of 3 rinse tanks connected in series, which are a first-stage rinse tank, a second-stage rinse tank and a third-stage rinse tank in turn, each stage of rinse tank is of anticorrosion steel structure, the water inlet pipe is arranged on the top part of each stage of rinse tank, the water outlet pipe is arranged on the bottom part of each stage of rinse tank, the water inlet pipe of a preceding-stage rinse tank is connected with the water outlet pipe of a next-stage rinse tank, rinse water is conveyed to the final-stage rinse tank through the water supply pump, the water flow direction is opposite to the movement direction of plating articles. A flow meter is equipped between two adjacent stages of rinse tanks. An emptying valve is arranged on the bottom part of each stage of rinse tank and is connected to an emptying pipe, through which the rinse water in the rinse tank is emptied so as to facilitate equipment inspection. Electromagnetic valves are arranged on both the water inlet pipe and the water outlet pipe, the liquid level sensor is arranged on the bottom part of each rinse tank, the top part of the final-stage rinse tank is also provided with a liquid level sensor, for preventing the final-stage rinse tank being over supplied to overflow. A conductivity electrode is arranged in the second-stage rinse tank. The PLC automatic control system includes a control module, a display screen, a power module and a monitoring module; the control module and the monitoring module are electrically connected with each other, signals of the liquid level sensor and the conductivity electrode are input to the monitoring module of the PLC automatic control system, so that the PLC automatic control system collects the information sensed by the conductivity electrode and the liquid level sensor in time and then transmits the signal to the control module of the PLC automatic control system, a signal output end of the control module is electrically connected with the control circuit of the water supply pump and the water discharge pump to control the switch of each water supply pump so as to realize automatic control of water supply and discharge; meanwhile, the control module also controls the automatic operation of the system; the control module, the display screen and the monitoring module all are powered by the power module, and the signal received by the control module is synchronously displayed through the display screen.

A use method of the intelligent water control equipment for intermittently countercurrent rinsing plating articles includes the following steps:

1) at the initial stage of rinsing, what in each stage of rinse tank is rinse water, detergent is fed to the first-stage rinse tank, the detergent being a mixed liquor composed of absolute ethyl alcohol, isopropyl alcohol, dimer fatty acid and acidic amine phosphate, with a mass ratio of 7:2:1:1; the preparation method of the detergent is: taking absolute ethyl alcohol, isopropyl alcohol, dimer fatty acid and acidic amine phosphate according to the mass ratio; pumping the dimer fatty acid into a blending kettle to heat to 35° C., then adding the acidic amine phosphate to stir for 1 min, next adding the absolute ethyl alcohol and the isopropyl alcohol, mixing thoroughly, ready to use; the dosage of the detergent is 0.1 g/L, wherein, as rinsing time increases, the concentration of each stage of rinse tank increases gradually;

2) when the conductivity of the second-stage rinse tank reaches a preset upper limit, the conductivity electrode transmits a signal to the PLC automatic control system, the PLC automatic control system triggers the program of automatic water change to start changing water, and, detergent is fed one time to the first-stage rinse tank each time water is changed; the system first automatically opens the water discharge pump of the first-stage rinse tank to discharge the rinse water in the first-stage rinse tank, after the first-stage rinse tank is emptied, the second-stage rinse water is totally input to the first-stage rinse tank through the PLC automatic control system, latter stages of rinse tanks change water in turn, and, when the third-stage rinse tank is emptied, the water supply pump is triggered to infuse clean rinse water to the third-stage rinse tank, the water supply pump is connected with a normal-temperature water tank and a hot water tank respectively for alternately supplying normal-temperature water and hot water, the temperature of the normal-temperature water is 15° C. and the temperature of the hot water is about 70° C.

3) when the third-stage rinse tank is full of rinse water, the liquid level sensor arranged on the top part is triggered, the liquid level sensor transmits a signal to the PLC automatic control system, and the PLC automatic control system triggers the water supply pump to stop supplying water, the system is capable of monitoring the water flow of water change of each stage of rinse tank and finding the leakage and venting condition of rinse water in time;

4) when inspecting and debugging the device, the PLC automatic control system is changed to manual control, so that the rinse water may be emptied manually through the emptying valve to facilitate equipment repair.

### Embodiment 2

An intelligent water control equipment for intermittently countercurrent rinsing plating articles includes a four-stage countercurrent rinse tank, a PLC automatic control system, a liquid level sensor, a water supply pump, a water discharge pump, a water inlet pipe and a water output pipe: the multi-stage countercurrent rinse tank is composed of 4 rinse tanks connected in series, which are a first-stage rinse tank, a second-stage rinse tank, a third-stage rinse tank and a fourth-stage rinse tank in turn, each stage of rinse tank is of anticorrosion steel structure, the water inlet pipe is arranged on the top part of each stage of rinse tank, the water outlet pipe is arranged on the bottom part of each stage of rinse tank, the water inlet pipe of a preceding-stage rinse tank is connected with the water outlet pipe of a next-stage rinse tank, rinse water is conveyed to the final-stage rinse tank through the water supply pump, the water flow direction is opposite to the movement direction of plating articles. A flow meter is equipped between two adjacent stages of rinse tanks. An emptying valve is arranged on the bottom part of each stage of rinse tank and is connected to an emptying pipe, through which the rinse water in the rinse tank is emptied so as to facilitate equipment inspection. Electromagnetic valves are arranged on both the water inlet pipe and the water outlet pipe, the liquid level sensor is arranged on the bottom part of each rinse tank, the top part of the final-stage rinse tank is also provided with a liquid level sensor, for preventing the final-stage rinse tank being over supplied to overflow. A conductivity electrode is arranged in the third-stage rinse tank. The PLC automatic control system includes a control module, a display screen, a power module and a monitoring module: the control module and the monitoring module are electrically connected with each other, signals of the liquid level sensor and the conductivity electrode are input to the monitoring module of the PLC automatic control system, so that the PLC automatic control system collects the information sensed by the conductivity electrode and the liquid level sensor in time and then transmits the signal to the control module of the PLC automatic control system, a signal output end of the control module is electrically connected with the control circuit of the water supply pump and the water discharge pump to control the switch of each water supply pump so as to realize automatic control of water supply and discharge; meanwhile, the control module also controls the automatic operation of the system; the control module, the display screen and the monitoring module all are powered by the power module, and the signal received by the control module is synchronously displayed through the display screen.

A use method of the intelligent water control equipment for intermittently countercurrent rinsing plating articles includes the following steps:

1) at the initial stage of rinsing, what in each stage of rinse tank is rinse water, detergent is fed to the first-stage rinse tank, the detergent being a mixed liquor composed of absolute ethyl alcohol, isopropyl alcohol, dimer fatty acid and acidic amine phosphate, with a mass ratio of 7:2:1:1; the preparation method of the detergent is: taking absolute ethyl alcohol, isopropyl alcohol, dimer fatty acid and acidic amine phosphate according to the mass ratio; pumping the dimer fatty acid into a blending kettle to heat to 36° C., then adding the acidic amine phosphate to stir for 2 min, next adding the absolute ethyl alcohol and the isopropyl alcohol, mixing thoroughly, ready to use; the dosage of the detergent is 0.40 g/L, wherein, as rinsing time increases, the concentration of each stage of rinse tank increases gradually;

2) when the conductivity of the third-stage rinse tank reaches a preset upper limit, the conductivity electrode transmits a signal to the PLC automatic control system, the PLC automatic control system triggers the program of automatic water change to start changing water, and, detergent is fed one time to the first-stage rinse tank each time water is changed; the system first automatically opens the water discharge pump of the first-stage rinse tank to discharge the rinse water in the first-stage rinse tank; after the first-stage rinse tank is emptied, the second-stage rinse water is totally input to the first-stage rinse tank through the PLC automatic control system, latter stages of rinse tanks change water in turn, and, when the fourth-stage rinse tank is emptied, the water supply pump is triggered to infuse clean rinse water to the fourth-stage rinse tank, the water supply pump is connected with a normal-temperature water tank and a hot water tank respectively for alternately supplying normal-temperature water and hot water, the temperature of the normal-temperature water is 18° C. and the temperature of the hot water is about 75° C;

3) when the final-stage rinse tank is full of rinse water, the liquid level sensor arranged on the top part is triggered, the liquid level sensor transmits a signal to the PLC automatic control system, and the PLC automatic control system triggers the water supply pump to stop supplying water, the system is capable of monitoring the water flow of water change of each stage of rinse tank and finding the leakage and venting condition of rinse water in time;

4) when inspecting and debugging the device, the PLC automatic control system is changed to manual control, so that the rinse water may be emptied manually through the emptying valve to facilitate equipment repair.

### Embodiment 3

An intelligent water control equipment for intermittently countercurrent rinsing plating articles includes a four-stage countercurrent rinse tank, a PLC automatic control system, a liquid level sensor, a water supply pump, a water discharge pump, a water inlet pipe and a water output pipe; the multi-stage countercurrent rinse tank is composed of 4 rinse tanks connected in series, which are a first-stage rinse tank, a second-stage rinse tank, a third-stage rinse tank and a fourth-stage rinse tank in turn, each stage of rinse tank is of anticorrosion steel structure, the water inlet pipe is arranged on the top part of each stage of rinse tank, the water outlet pipe is arranged on the bottom part of each stage of rinse tank, the water inlet pipe of a preceding-stage rinse tank is connected with the water outlet pipe of a next-stage rinse tank, rinse water is conveyed to the final-stage rinse tank through the water supply pump, the water flow direction is opposite to the movement direction of plating articles. A delivery pump adopts a flow pump. An emptying valve is arranged on the bottom part of each stage of rinse tank and is connected to an emptying pipe, through which the rinse water in the rinse tank is emptied so as to facilitate equipment inspection. Electromagnetic valves are arranged on both the water inlet pipe and the water outlet pipe, the liquid level sensor is arranged on the bottom part of each rinse tank, the top part of the final stage rinse tank is also provided with a liquid level sensor, for preventing the final-stage rinse tank being over supplied to overflow. The first-stage rinse tank is further provided with a detergent feeding device. A conductivity electrode is arranged in the third-stage rinse tank. The PLC automatic control system includes a control module, a display screen, a power module and a monitoring module; the control module and the monitoring module are electrically connected with each other, signals of the liquid level sensor and the conductivity electrode are input to the monitoring module of the PLC automatic control system, so that the PLC automatic control system collects the information sensed by the conductivity electrode and the liquid level sensor in time and then transmits the signal to the control module of the PLC automatic control system, a signal output end of the control module is electrically connected with the control circuit of the water supply pump and the water discharge pump to control the switch of each water supply pump so as to realize automatic control of water supply and discharge; meanwhile, the control module also controls the automatic operation of the system; the control module, the display screen and the monitoring module all are powered by the power module, and the signal received by the control module is synchronously displayed through the display screen.

A use method of the intelligent water control equipment for intermittently countercurrent rinsing plating articles includes the following steps;

1) at the initial stage of rinsing, what in each stage of rinse tank is rinse water, detergent is fed to the first-stage rinse tank, the detergent being a mixed liquor composed of absolute ethyl alcohol, isopropyl alcohol, dimer fatty acid and acidic amine phosphate, with a mass ratio of 7:2:1:1; the preparation method of the detergent is: taking absolute ethyl alcohol, isopropyl alcohol, dimer fatty acid and acidic amine phosphate according to the mass ratio; pumping the dimer fatty acid into a blending kettle to heat to 37° C., then adding the acidic amine phosphate to stir for 4 min, next adding the absolute ethyl alcohol and the isopropyl alcohol, mixing thoroughly, ready to use; the dosage of the detergent is 0.8 g/L, wherein, as rinsing time increases, the concentration of each stage of rinse tank increases gradually;

2) when the conductivity of the third-stage rinse tank reaches a preset upper limit, the conductivity electrode transmits a signal to the PLC automatic control system, the PLC automatic control system triggers the program of automatic water change to start changing water, and, detergent is fed one time to the first-stage rinse tank each time water is changed; the system first automatically opens the water discharge pump of the first-stage rinse tank to discharge the rinse water in the first-stage rinse tank; after the first-stage rinse tank is emptied, the second-stage rinse water is totally input to the first-stage rinse tank through the PLC automatic control system, latter stages of rinse tanks change water in turn, and, when the fourth-stage rinse tank is emptied, the water supply pump is triggered to infuse clean rinse water to the fourth-stage rinse tank, the water supply pump is connected with a normal-temperature water tank and a hot water tank respectively for alternately supplying normal-temperature water and hot water, the temperature of the normal-temperature water is 22° C. and the temperature of the hot water is about 80° C.;

3) when the fourth-stage rinse tank is full of rinse water, the liquid level sensor arranged on the top part is triggered, the liquid level sensor transmits a signal to the PLC automatic control system, and the PLC automatic control system triggers the water supply pump, to stop supplying water, the system is capable of monitoring the water flow of water change of each stage of rinse tank and finding the leakage and venting condition of rinse water in time;

4) when inspecting and debugging the device, the PLC automatic control system is changed to manual control, so that the rinse water may be emptied manually through the emptying valve to facilitate equipment repair.

### Embodiment 4

An intelligent water control equipment for intermittently countercurrent rinsing plating articles includes a five-stage countercurrent rinse tank, a PLC automatic control system, a liquid level sensor, a water supply pump, a water discharge pump, a water inlet pipe and a water output pipe; the multi-stage countercurrent rinse tank is composed of 5 rinse tanks connected in series, which are a first-stage rinse tank, a second-stage rinse tank, a third-stage rinse tank, a fourth-stage rinse tank and a fifth-stage rinse tank in turn, each stage of rinse tank is of anticorrosion steel structure, the water inlet pipe is arranged on the top part of each stage of rinse tank, the water, outlet pipe is arranged on the bottom part of each stage of rinse tank, the water inlet pipe of a preceding-stage rinse tank is connected with the water outlet pipe of a next-stage rinse tank, rinse water is conveyed to the final-stage rinse tank through the water supply pump, the water flow direction is opposite to the movement direction of plating articles. A delivery pump adopts a flow pump. An emptying valve is arranged on the bottom part of each stage of rinse tank and is connected to an emptying pipe, through which the rinse water in the rinse tank is emptied so as to facilitate equipment inspection. Electromagnetic valves are arranged on both the water inlet pipe and the water outlet pipe, the liquid level sensor is arranged on the bottom part of each rinse tank, the top part of the final-stage rinse tank is also provided with a liquid level sensor, for preventing the final-stage rinse tank being over supplied to overflow. The first-stage rinse tank is further provided with a detergent feeding device. A conductivity electrode is arranged in the fourth-stage rinse tank. The PLC automatic control system includes a control module, a display screen, a power module and a monitoring module; the control module and the monitoring module are electrically connected with each other, signals of the liquid level sensor and the conductivity electrode are input to the monitoring module of the PLC automatic control system, so that the PLC automatic control system collects the information sensed by the conductivity electrode and the liquid level sensor in time and then transmits the signal to the control module of the PLC automatic control system, a signal output end of the control module is electrically connected with the control circuit of the water supply pump and the water discharge pump to control the switch of each water supply pump so as to realize automatic control of water supply and discharge; meanwhile, the control module also controls the automatic operation of the system; the control module, the display screen and the monitoring module all are powered by the power module, and the signal received by the control module is synchronously displayed through the display screen.

A use method of the intelligent water control equipment for intermittently countercurrent rinsing plating articles includes the following steps:

1) at the initial stage of rinsing, what in each stage of rinse tank is rinse water, detergent is fed to the first-stage rinse tank, the detergent being a mixed liquor composed of absolute ethyl alcohol, isopropyl alcohol, dimer fatty acid and acidic amine phosphate, with a mass ratio of 7:2:1:1; the preparation method of the detergent is: taking absolute ethyl alcohol, isopropyl alcohol, dimer fatty acid and acidic amine phosphate according to the mass ratio; pumping the dimer fatty acid into blending kettle to heat to 40° C., then adding the acidic amine phosphate to stir for 5 min, next adding the absolute ethyl alcohol and the isopropyl alcohol, mixing thoroughly, ready to use; the dosage of the detergent is 1.2 g/L, wherein, as rinsing time increases, the concentration of each stage of rinse tank increases gradually;

2) when the conductivity of the fourth-stage rinse tank reaches a preset upper limit, the conductivity electrode transmits a signal to the PLC automatic control system, the PLC automatic control system triggers the program of automatic water change to start changing water, and, detergent is fed one time to the first-stage rinse tank each time water is changed; the system first automatically opens the water discharge pump of the first-stage rinse tank to discharge the rinse water in the first-stage rinse tank; after the first-stage rinse tank is emptied, the second-stage rinse water is totally input to the first-stage rinse tank through the PLC automatic control system, latter stages of rinse tanks change water in turn, and, when the fifth-stage rinse tank is emptied, the water supply pump is triggered to infuse clean rinse water to the fifth-stage rinse tank, the water supply pump is connected with a normal-temperature water tank and a hot water tank respectively for alternately supplying normal-temperature water and hot water, the temperature of the normal-temperature water is 25° C. and the temperature of the hot water is about 90° C.;

3) when the fifth-stage rinse tank is full of rinse water, the liquid level sensor arranged on the top part is triggered, the liquid level sensor transmits a signal to the PLC automatic control system, and the PLC automatic control system triggers the water supply pump to stop supplying water, the system is capable of monitoring the water flow of water change of each stage of rinse tank and finding the leakage and venting condition of rinse water in time;

4) when inspecting and debugging the device, the PLC automatic control system is changed to manual control, so that the rinse water may be emptied manually through the emptying valve to facilitate equipment repair,

It should be noted that, even though the disclosure has been described above in detail in conjunction with the accompanying drawings, we think the applicable scope of the disclosure is not limited to the above method. Any modifications, equivalent substitutions or improvements made within the spirit and principle of the disclosure are intended to be within the scope of protection of the disclosure. The scope of protection of the disclosure is based on claims appended herein,

We claim:

1. An intelligent water control equipment for intermittently countercurrent rinsing plating articles characterized in that: the intelligent water control equipment comprises a multi-stage countercurrent rinse tank, a PLC automatic control system, a liquid level sensor, a water supply pump, a water discharge pump, a water inlet pipe and a water output pipe; the multi-stage countercurrent rinse tank is composed of n rinse tanks connected in series, n being a natural number greater than 2 but less than 10, representing a first-stage rinse tank, a second-stage rinse tank . . . a final-stage rinse tank in turn, the water inlet pipe is arranged on the top part of each stage of rinse tank, the water outlet pipe is arranged on the bottom part of each stage of rinse tank, the water inlet pipe of a preceding-stage rinse tank is connected with the water outlet pipe of a next-stage rinse tank, rinse water is conveyed to the final-stage rinse tank through the water supply pump, the water flow direction is opposite to the movement direction of plating articles; an emptying valve is arranged on the bottom part of each stage of rinse tank and is connected to an emptying pipe, through which the rinse water in the rinse tank is emptied;
electromagnetic valves are arranged on both the water inlet pipe and the water outlet pipe, the liquid level sensor is arranged on the bottom part of each rinse tank, the top part of the final-stage rinse tank is also provided with a liquid level sensor, a conductivity electrode is arranged in the second last stage of rinse tank, signals of the liquid level sensor and the conductivity electrode are input to the PLC automatic control system, and a signal output end of the PLC automatic control system is electrically connected with a control circuit of the water supply pump and the water discharge pump.

2. The intelligent water control equipment for intermittently countercurrent, rinsing plating articles according to claim 1, characterized in that a flow meter is equipped between two adjacent stages of rinse tanks or a delivery pump adopts a flow pump.

3. The intelligent water control equipment for intermittently countercurrent rinsing plating articles according to claim 1, characterized in that the rinse tank is of anticorrosion steel structure.

4. The intelligent water control equipment for intermittently countercurrent rinsing plating articles according to claim 1, characterized in that the first-stage rinse tank is further provided with a detergent feeding device.

5. The intelligent water control equipment for intermittently countercurrent rinsing, plating articles according to claim 1 characterized in that the PLC automatic control system comprises a control module, a display screen, a power module and a monitoring module; the control module and the monitoring module are electrically connected with each other, signals of the liquid level sensor and the conductivity electrode are input to the monitoring module of the PLC automatic control system, so that the PLC automatic control system collects the information sensed by the conductivity electrode and the liquid level sensor in time and then transmits the signal to the control module of the PLC automatic control system, a signal output end of the control module is electrically connected with the control circuit of the water supply pump and the water discharge pump to control the switch of each water supply pump so as to realize automatic control of water supply and discharge; meanwhile, the control module also controls the automatic operation of the system; the control module, the display screen and the monitoring module all are powered by the power module, and the signal received by the control module is synchronously displayed through the display screen.

6. A use method of the intelligent water control equipment for intermittently countercurrent rinsing plating articles described in claim 1, characterized in that the method comprises the following steps:
1) at the initial stage of rinsing, what in each stage of rinse tank being rinse water, feeding detergent to the first-stage rinse tank, the detergent being a mixed liquor composed of absolute ethyl alcohol, isopropyl alcohol dimer fatty acid and amine phosphate, with a mass ratio of 7:2:1:1, the dosage of the detergent being 0.1-1.2 g/L, best 0.4 g/L, wherein, as rinsing time increases, the concentration of each stage of rinse tank increases gradually;
2) when the conductivity of the second last stage of rinse tank reaches a preset upper limit, the conductivity electrode transmitting a signal to the PLC automatic control system, the PLC automatic control system triggering the program of automatic water change to start changing water, and, feeding one time detergent to the first-stage rinse tank each time water is changed; the system first automatically opening the water discharge pump of the first-stage rinse tank to discharge the rinse water in the first-stage rinse tank; after the first-stage rinse tank is emptied, totally inputting the second-stage rinse water to the first-stage rinse tank through the PLC automatic control system, latter stages of rinse tanks changing water in turn, and, when the final-stage rinse tank is emptied, triggering the water supply pump to infuse clean rinse water to the final-stage rinse tank, the water supply pump being connected with a normal-temperature water tank and a hot water tank respectively for alternately supplying normal-temperature water and hot water, the temperature of the normal-temperature water being 20±5° C. and the temperature of the hot water being about 80±10° C.;
3) when the final-stage rinse tank is full of rinse water, triggering the liquid level sensor arranged on the top part, the liquid level sensor transmitting a signal to the PLC automatic control system, and the PLC automatic control system triggering the water supply pump to stop supplying water, the system being capable of monitoring the water flow of water change of each stage of rinse tank and finding the leakage and venting condition of rinse water in time;
4) when inspecting and debugging the device, changing the PLC automatic control system to manual control, so that the rinse water may be emptied manually through the emptying valve to facilitate equipment repair.

7. The use method of the intelligent water control equipment for intermittently countercurrent rinsing plating articles according to claim 6, characterized in that the amine phosphate is acidic amine phosphate,

8. The use method of the intelligent water control equipment for intermittently countercurrent rinsing plating articles according to claim 6, characterized in that the preparation method of the detergent is: taking absolute ethyl alcohol, isopropyl alcohol, dimer fatty acid and acidic amine phosphate according to the mass ratio; pumping the dimer fatty acid into a blending kettle to heat to 35 to 4° C., then adding the acidic amine phosphate to stir for to 1 to 5 min, next adding the absolute ethyl alcohol and the isopropyl alcohol, mixing thoroughly, ready to use.
